(19) United States
(12) Patent Application Publication
(10) Pub. No.: US 2012/0326988 A1
(43) Pub. Date: Dec. 27, 2012

(54) MULTILINGUAL KEY INPUT APPARATUS AND METHOD THEREOF

(76) Inventor: Soon Jo Woo, Gyeonggi-Do (KR)

(21) Appl. No.: 13/579,267

(22) PCT Filed: Feb. 21, 2011
(86) PCT No.: PCT/KR2011/001127

§ 371 Date: Aug. 15, 2012

(30) Foreign Application Priority Data
Feb. 19, 2010 (KR) 10-2010-0015384
Nov. 3, 2010 (KR) 10-2010-0108848

(51) Int. Cl. G06F 3/02

(52) U.S. Cl. 345/171

(57) ABSTRACT

Disclosed is a multilingual key input apparatus and method capable of inputting a plurality of keys and outputting a character corresponding to a combination of the input keys. Upon a reference key being input, at least one associated key including inputtable characters is displayed on a screen. When the input of the associated key is detected within a preset time, a character selected by the detected reference key and associated key or a character selected by using the selected character as a reference key and recursively using the succeeding key as an associated key is output as a target character. The key input includes an actual key input, a touch and a touch & drag, and especially, displaying and outputting a character is controlled according to a dragged position and direction of the touch & drag.

### TECHNICAL FIELD

The present invention relates to a multilingual key input apparatus capable of conveniently inputting characters by a recursive key input, and a method thereof.

### BACKGROUND ART

In general, computers or mobile terminals can be allowed to compose text such as memos or messages. The computer or mobile terminal may have a user input unit, such as a keyboard, a keypad or a touch screen, for text composition. However, the number of keys included in the user input unit is typically smaller than the number of characters, letters or the like for text. Hence, at least plural (two or more) characters (Korean, English, etc.) are assigned to each key constructing a user input unit.

As such, when plural characters are assigned to one key, assigned characters are sequentially input every time the corresponding key is entered consecutively within a preset time.

However, when the plural characters assigned to one key have to be consecutively input, a user should wait for until a cursor is automatically moved to the next character input position or should directly move the cursor to the next character input position to input the next character, which causes the input of the character to be complicated and more time to be required for the character input.

Furthermore, when the plural characters are assigned to one key, character input may be executed by using one hand. Thus, it may require more time to input characters than inputting characters with both hands.

Even in regard of an input device including relatively many keys, such as a keyboard of a computer, some characters belonging to languages (e.g., Chinese, Japanese, etc.) may not have proper keys in the user input unit. For example, characters with umlaut ( ) in German, and characters with accent aigu ( ) accent grave (`) or accent circonflexe (̂) in French are not properly assigned to keys on a commonly used QWERTY-type keyboard.

Hence, such special characters as mentioned above may not be input directly by an ordinary keyboard. In order to input the special characters, a user needs to open a window with a list of characters on it, and then select a desired character from the displayed list of characters for input.

In short, particular keys such as navigation keys or an enter key should be input (entered, touched, pressed) several times for selection of a character, which may cause a user's burden. Also, such character input manner may require longer time to input characters.

### DISCLOSURE OF INVENTION

### Technical Problem

Therefore, an aspect of the present disclosure is to provide a multilingual key input apparatus capable of conveniently inputting a desired character by employing a recursive key input mechanism, and a method thereof.

Another aspect of the present disclosure is to provide a multilingual key input apparatus capable of more conveniently inputting special characters, which cannot be input through keys, and a method thereof.

Another aspect of the present disclosure is to provide a multilingual key input apparatus capable of facilitating input of variable extension characters related to a selected character by entering a succeeding associated key in a state that a special character is selected by a reference key and an associated key, and a method thereof.

### Solution to Problem

To achieve these and other advantages and in accordance with the purpose of the present invention, as embodied and broadly described herein, there is provided a multilingual key input method for inputting characters by a key input in a key arrangement including a plurality of keys, each having a plurality of characters assigned, the method including detecting whether or not a reference key is input, activating a preset keypad or keyboard related to the reference key in response to the input of the reference key, to display at least one associated key having inputtable characters, detecting whether or not the associated key is input within a preset time, and outputting a character selected by the detected reference key and associated key or a character selected by using the selected character as a reference key and recursively using the succeeding key as an associated key as a target character.

Preferably, upon the reference key being input, the other characters excluding the first character of the plurality of characters assigned to the reference key or extension characters may be displayed on associated keys present at a specific column or row of the keyboard or the keypad or the touch screen or the touch screen. Here, the characters included in the reference key may be displayed on divided regions of the keyboard or the keypad, and the extension characters may be displayed on associated keys displayed on regions other than the regions for displaying the characters included in the reference key thereon.

The target character may include a character assigned to the reference key, an extension character and a complete letter, and the associated key may include a function key(s) for inputting a special character including a punctuation mark or an emoticon.

Upon the reference key being input, the other characters excluding the first character of the plurality of characters assigned to the reference key or extension characters may be displayed on associated keys present at a specific column or row of the keyboard or the keypad.

The characters included in the reference key may be displayed on divided regions of the keyboard or the keypad, and the extension characters may be displayed on associated keys displayed on regions other than the regions for displaying the characters included in the reference key thereon.

In accordance with one exemplary embodiment, there is provided a multilingual key input apparatus for inputting a character by a key input in a key arrangement having a plurality of keys, each having a plurality of characters assigned, the apparatus including a user input unit configured to allow a user to input a key, a memory configured to store a character assignment table corresponding to a plurality of key combinations, a display unit configured to display a keypad arrangement converted responsive to the key input and a character decided based on the character assignment table in response to the key input, and a controller configured to display at least one associated key including inputtable characters when a reference key is input, and to output a character selected by the detected reference key and associated key or a character selected by using the selected character as a reference key and recursively using the succeeding key as an associated key as a target character.

Preferably, the reference key and the associated key may be input by virtue of keys or touch, and the input of the reference key may be a touch input while the input of the associated key may be a touch & drag.

Preferably, upon the reference key being input, the other characters excluding the first character of the plurality of characters assigned to the reference key or extension characters may be displayed on associated keys present at a specific column or row of a keyboard or a keypad. Here, the characters included in the reference key may be displayed on divided regions of a keyboard or a keypad, and the extension characters may be displayed on associated keys displayed on regions other than the regions for displaying the characters included in the reference key thereon.

The key arrangement and the inputtable characters may be displayed by being changed every time a basic (i.e., reference key) key and the associated key are input, and the key arrangement may be differently displayed according to an input order of the reference key and the associated key.

### Advantageous Effects of Invention

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

### BRIEF DESCRIPTION OF DRAWINGS

FIG. 1 is a block diagram illustrating a construction of a multilingual key input apparatus in accordance with an exemplary embodiment;

FIG. 2 is an exemplary view illustrating a construction of a keypad of a mobile terminal in accordance with the present disclosure;

FIG. 3 is a view illustrating an example of inputting characters using a consonant region and a vowel region in a Korean keyboard (keypad) structure in accordance with an exemplary embodiment;

FIG. 4 is a view illustrating another example of inputting characters using the consonant region and the vowel region in the Korean keyboard (keypad) structure in accordance with the exemplary embodiment;

FIG. 5 is a view illustrating an example of displaying and inputting diphthongs and geminates as extension characters in the Korean keyboard (keypad) structure in accordance with the exemplary embodiment;

FIG. 6 is a view illustrating an exemplary embodiment of a multilingual key input method;

FIG. 7 is a view illustrating an exemplary embodiment of inputting Japanese characters by the multilingual key input method;

FIG. 8 is a view illustrating an example having a new English keyboard (keypad) structure in accordance with an exemplary embodiment;

FIG. 9 is a view illustrating an example of inputting characters using the new English keyboard (keypad) illustrated in FIG. 8;

FIG. 10 is a flowchart illustrating a multilingual key input method in accordance with an exemplary embodiment;

FIG. 11 is an exemplary view illustrating the multilingual key input method illustrated in FIG. 10;

FIG. 12 is an exemplary view illustrating the multilingual key input method performed by a touch& drag in accordance with an exemplary embodiment;

FIG. 13 is an exemplary view for inputting a character by a touch & drag in the key input method illustrated in FIG. 11;

FIG. 14 is an exemplary view illustrating a character assignment table of a memory containing characters corresponding to a set (combination) of plural keys.

### MODE FOR THE INVENTION

Hereinafter, a multilingual key input apparatus associated with the present disclosure will be described in more detail with reference to the accompanying drawings. A suffix “module” or “unit” used for constituent elements disclosed in the following description is merely intended for easy description of the specification, and the suffix itself does not give any special meaning or function.

A multilingual variable key consecutive input apparatus may be applied to a mobile terminal such as a cellular phone or a smart phone and any apparatus employing keys as an input element or a part, such as a laptop computer, a personal digital assistant (PDA), a portable multimedia player (PMP), a remote controller associated with a television set, and the like.

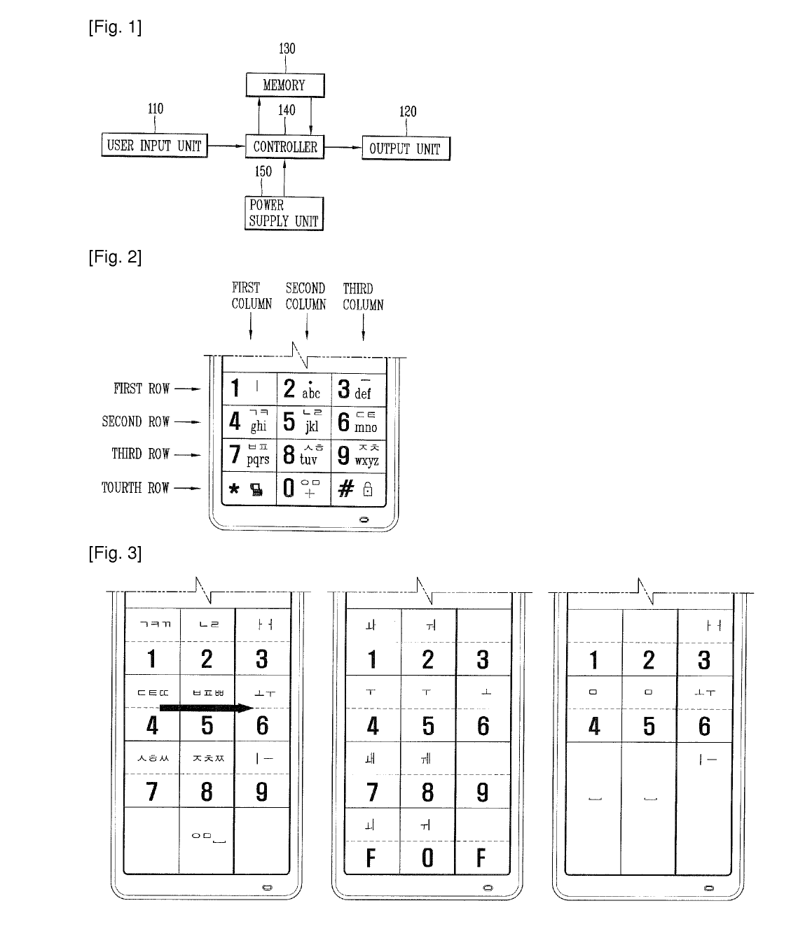

FIG. 1 is a block diagram illustrating a construction of a multilingual key input apparatus 100 in accordance with an exemplary embodiment.

As shown in FIG. 1, a multilingual key input apparatus 100 may include a user input unit 110, an output unit 120, a memory 130, a controller 140, a power supply unit 150 and the like. Here, all of the elements as illustrated in FIG. 1 are not necessarily required, and the input apparatus may be implemented with greater or less number of elements than those illustrated elements.

Also, keys applied to this specification may include hardware keys (hereinafter, referred to as a hard key), such as buttons, and software keys (hereinafter, referred to as a soft key) displayed on a touch screen.

Hereinafter, the constituent elements will be described in turn.

The user input unit 110 may allow a user to generate input data for control of operations of the key input apparatus. The user input unit 110 may be configured as a keyboard, a keypad, a dome switch, a touchpad (pressure/capacitance), a touch screen and the like.

The output unit 120 may include a display unit (not shown) and an audio output module (not shown). The display unit may display (output) information input via the key input apparatus 100. For example, when the user input unit 110 is a touch screen, user interface (UI) or graphic user interface (GUI) related to a key input may be displayed. Alternatively, a character(s) assigned to an input key may be displayed.

The display unit may include at least one of a Liquid Crystal Display (LCD), a Thin Film Transistor-LCD (TFT-LCD), an Organic Light Emitting Diode (OLED) display, a flexible display, and a three-dimensional (3D) display.

In embodiments where the display unit and a touch sensitive sensor (hereinafter, referred to as ‘touch sensor’) have an interlayer structure (hereinafter referred to as ‘touch screen’, the display unit may be used as an input device in addition to being used as an output device.

The touch sensor may be implemented as a touch film, a touch sheet, a touch pad, and the like. The touch sensor may be configured to convert changes of pressure applied to a specific part of the display unit, or a capacitance occurring from a specific part of the display unit, into electric input signals. Also, the touch sensor may be configured to sense not only a touched position and a touched area, but also a touch pressure.

The audio output module may output an audio signal generated in response to a key input, and use audio data stored in the memory 130 for output of the audio signal.

The memory 130 may store a program for operations of the controller 140 related to processing of input keys. The memory 130 may be implemented using at least one type of suitable storage media including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like.

The controller 140 may typically control the overall operations of the key input apparatus 100. For example, the controller 140 may perform control and processing related to input of keys and output of text (characters, letters). The power supply unit 150 may provide power required by various components under the control of the controller 140. The provided power may be internal power, external power, or combination thereof.

Various embodiments described herein may be implemented within a storage medium readable by a computer or other similar devices using software, hardware or some combination thereof.

Hereinafter, description will be given of various embodiments of a key input method, which will be realized in the multilingual key input apparatus having such construction, with reference to the accompanying drawings. The following embodiments may be used independently or in combination. Also, the following embodiments may be used in combination with the user interfaces (UIs).

Basically, this specification may be implemented such that upon a reference key being entered, at least one associated key containing inputtable characters is displayed, and then when an input of the associated key is detected for a preset time, a character decided (selected) by the reference key and the associated key may be output as a target character, or the decided character may be re-used as a reference key and the succeeding key may be recursively used as an associated key so as to output a character decided by the two keys as a target character.

FIG. 2 is an exemplary view illustrating a structure of a keypad (key arrangement) according to the present disclosure.

As illustrated in FIG. 2, a keypad may include a plurality of character sets per language, and each key may be assigned with a plurality of characters (letters). Hence, the keypad may be configured to select and input a language, namely, a character set, to be input according to a text input mode. The text input mode may be converted by repetitively inputting a preset key on an initial keypad (key arrangement) screen. Alternatively, a preset key may be entered to activate various types of keypads to be convertible on the other keys and display the activated keypads, and then a key having a target keypad assigned thereto may be entered to convert a keypad through a simultaneous input mechanism.

For example, assuming that one key, to which three types of language-based character sets are assigned, is input via the keypad, a number assigned to the corresponding key is output if the text input mode is a number input mode, a Korean character assigned to the corresponding key is output if the text input mode is a Korean input mode, and an English letter (character, alphabet) assigned to the corresponding key is output if the text input mode is an English input mode.

For the sake of explanation, keys having characters assigned on the keypad are divided into columns and rows. For example, a row of numeric 1, 2 and 3 keys is defined as a first row, a row of numeric 4, 5 and 6 keys as a second row, and a row of numeric 7, 8 and 9 keys as a third row on the keypad. Also, a column of numeric 1, 4 and 7 keys is defined as a first column, a column of numeric 2, 5 and 8 keys as a second column and a column of numeric 3, 6 and 9 keys as a third column on the keypad. Similar to this, a fourth column and a fourth row may further be defined.

The controller 140 may detect (sense) one key, which is the first input of the keys, as a reference key, and determine the number and type of characters assigned to the one key. For example, it is assumed that the one key is a numeric 4 key and three English alphabets (characters) ‘g, h, i’ are assigned to the numeric 4 key.

When one key is input in the related art, the controller 140 has deactivated inputting of the other keys.

However, the present disclosure may be configured to activate inputting of the other keys even when one key (e.g. numeric 4 key) is entered. Here, it may be possible to deactivate the other keys (e.g., 5 and 6 keys and 1 and 7 keys) present on a row (e.g., second row) and a column (e.g., first column), to which the one key (e.g., the numeric 4 key) belongs. This is to prevent adjacent keys, which a user does not intend to press or touch, from being simultaneously entered in case where those keys are small in size.

However, the deactivation of the adjacent keys may not always be necessary but be done when needed. Such activation or deactivation may be selectively applied according to the characteristic of character sets of a language to be input. For example, when one key present at a first row is entered in English (alphabet input mode), the other keys belongs to the first row may be deactivated. Also, when one key present at the first is row entered in English (alphabet input mode), the other keys belonging to the first row may be activated under condition of having the same value as that of the second row.

To the contrary, in regard of languages, such as Korean or Japanese, having many characters (letters) to be input, all the keys excluding an input key may be activated. For example, for inputting Japanese, if a numeric 1 key has five assigned characters [symbol] , in a state of the numeric 1 key being pressed, a second key, to which the other four characters are to be assigned, should be distributed into four regions. In this case, it is necessary to assign [symbol] to the numeric 2 and 3 keys other than the numeric 1 key of the first row, [symbol] to the numeric 4, 5 and 6 keys of the second row, [symbol] to the numeric 7, 8 and 9 keys of the third row, and [symbol] to a part or all of keys of the fourth row. Hence, this case may need to activate all the keys excluding the already entered first key.

Such activated other keys may additionally be entered in a state of the one key (e.g., numeric 4 key) being entered. Hereinafter, inputting one key refers to a state that a user keeps pressing the key (i.e., a state that the key input is not released yet).

Typically, a character set to a certain key is input at the moment when the user enters the key, for example, with a finger, and takes the finger away within a specific time (e.g., 0.5 second) (i.e., at the moment of the key input being released). Hence, in this specification, while the key (hereinafter, referred to as ‘reference key’ is input, one key (hereinafter, referred to as a succeeding key) of the other activated keys may further be input. As such, the operation that the user additionally input the succeeding key while entering one reference key is described as a plurality of keys being simultaneously input. Even if the plurality of keys are simultaneously input, the input order may be different depending on an input time.

The simultaneous inputting of the plurality of keys may allow one of a plurality of characters to be immediately input through the simultaneous key input mechanism even if the plurality of characters are assigned to a certain key. Alternatively, the simultaneous inputting of the plurality of keys may allow a special character not assigned to a key or a character having a nasal vowel symbol or a diacritic mark (identifier) to be immediately input.

Here, when the plurality of keys are simultaneously input, a high priority for character input may be set to a key, which is input later. For example, it is assumed that in a state of the numeric 4 key being input, one of keys (e.g., 5 and 6 keys) present at the second row or keys (e.g., 7, 8 and 9 keys) present at the third row is simultaneously input. In the state of the plurality of keys being input, the early-input key (i.e., a key having a low priority) may be released after the later-input key (i.e., a key having a high priority) is released or the later-input key (i.e., the key having the high priority) may be released after the early-input key (i.e., the key having the low priority) is released.

The present disclosure may also set the same priority to the two simultaneously input keys. Hence, it may be processed as all the keys have been released once one of the two simultaneously input keys is released, or inputting may be completed only when both of the two keys should be released.

As such, the controller 140 may get inputs of a plurality of keys simultaneously in series so as to output a character (letter) corresponding to a combination of the keys. When the plurality of input keys are all released, the controller 140 may get an input of a new key or inputs of a plurality of new keys to output a corresponding character.

The exemplary embodiment in this specification may be configured such that even in any of the above cases, if a key having a high priority is released, a character corresponding to the combined keys can be input.

For example, it is assumed that one of a plurality of characters (e.g., g, h, i) assigned to a particular key (e.g., a numeric 4 key) is input according to the above method. That is, a user can input only the numeric 4 key, input the numeric 4 key and one of keys (associated key) present at the second row at the same time, or input the numeric 4 key and one of keys present at the third row at the same time. Accordingly, in this embodiment, ‘g’ may be input when the numeric 4 key is input individually, ‘h’ may be input when the numeric 4 key and one key present at the second row are simultaneously input, and ‘i’ may be input when the numeric 4 key and one key present at the third row are simultaneously input.

Here, a key having a plurality of specific characters assigned thereto is referred to as ‘reference key,’ and a key, which is simultaneously input with a specific reference key so as to allow inputting of a second or third character assigned to the reference key is referred to as ‘associated key,’ Also, characters assigned to the reference key are referred to as ‘basic characters,’ and a character, which is selected by simultaneously inputting the reference key and the associated key is referred to as ‘target character.’ Keys, which are not assigned with characters and used for conversion of a keypad or row change is referred to as ‘function key.’ A character, which is activated by pressing a function key, other than basic characters assigned to the basic key, or a character, which is further assigned to a key having no assigned associated key, is referred to as ‘extension character.’

Preferably, the extension characters may include alphabets including all characters excluding characters included in the basic (i.e., reference) keys. Examples of the extension character may include characters carrying various diacritic marks on themselves, such as umlaut symbols, accent marks in French or the like, Japanese Gana characters having sonant or semi-sonant marks, characters for spelling Chinese Pinyin including tones from first to fourth tones, Korean diphthongs and geminates and the like.

The embodiment has illustrated the method in which a reference key present at a second row and an associated key included in the rest of keys at the second row or keys at a third row are simultaneously entered (selected) to input a character corresponding to the combination of the keys.

The present disclosure may not be limited to the combination of the reference key and the associated key. Such method may be repetitively applied. That is, a target character decided (selected) by entering (pressing, touching) a reference key and an associated key is set as a reference key and an additionally input key (succeeding key) is set as an associated key, thereby outputting a target character corresponding to the combination of the two keys. This method may be recursively applied. For consistency and convenience of explanation, an open syllable word in Korean (i.e., a syllable without a final consonant), which is composed by consecutively inputting keys of a consonant part and a vowel part, is also regarded as a type of extension character in this specification.

In a state that a target character has been selected from basic characters by individually inputting a reference key or simultaneously inputting a reference key and an associated key, a function key may be entered (pressed, touched) as an associated key without a reference key released, to input a character (i.e., ‘extension character’), which is not provided in the basic characters assigned to the reference keys but is related to a target character.

For example, if one of function keys is entered as an associated key in a state of a numeric 4 key (reference key) being pressed, a capital letter ‘G’ of ‘g’ as the first character of the numeric 4 key may be output by the simultaneous input of the numeric 4 key and the function key. Similarly, in a state of the numeric 4 key being pressed, the numeric 5 or 6 key present at the second row may be input, to output ‘h’ as a target character. Afterwards, a function key may be entered without release of the reference key, to output a capital letter ‘H’ of ‘h’. In Short, it may also be possible to activate new characters, which are to be input at each step of simultaneous input, starting from inputting the reference key.

The multilingual key input method may not be always limited to the use of two hands (or fingers).

Depending on devices to be applied, even use of a hand (or finger) may implement various methods, by which the effects of the present disclosure are acquirable. For example, a first key may be consecutively input within a preset time (e.g., 0.3 second), thereby maintaining a state of the first key being input even after the input of the first key is released.

This method may be repetitively applied for the following input keys. For example, a first key may be consecutively input within a preset time to activate characters assigned to the first key at a specific position on a keyboard or keypad, and thereafter one of the activated keys may be consecutively input within a preset time to maintain a preset keypad (key arrangement) activated by the combination of the first key and the second key.

Also, in the present disclosure, if a reference key is kept pressed (entered or touched) for more than a preset time, a preset keypad (key arrangement) activated by the reference key may be fixed, thereby acquiring the same effect as the reference key is being entered even after release of the reference key. This method may be configured to guide a timing for inputting a succeeding key by using a method of, for example, generating a signal sound when the preset time elapses. This method may be repetitively applied to keys, which are subsequently input.

It may be implemented in a manner of waiting for the subsequent input by pressing a specific key to set a key (character) arrangement activated by the next input key. For example, if inputting is executed after pressing a volume key present at a side surface of a cellular phone, an activated key (character) arrangement may be set (fixed).

For a device having a touch screen, in addition to the above method, a method may be introduced in which in a state of one key being touched, the touch is dragged to a position, at which a second key is located, such that a touch point of the first touch may be set as a first key and a touch-released point may be set as a second key. This method may also be repetitively applied. For example, after a first key is touched to be dragged to a position where a second key is located, the touch is dragged to a position of a third key by switching the touch direction or after a waiting time, thereby realizing a a consecutive input. Depending on languages, if a few characters are assigned to one key, the present disclosure may be implemented in a manner of popping key (i.e., character) arrangements up as many as the number of candidate characters to be input without conversion of the entire key arrangements.

Also, the present disclosure may be implemented in a manner that a first key is flickered irrespective of directions in a state of being entered to fix a key (character) arrangement activated by the first key, thus to wait for the next key input. The method for maintaining the key-input state may allow inputting of characters using the apparatus of this specification according to the method of this specification under situations that one hand is in trouble or only one hand is temporarily allowed to be used.

Also, in regard of a language, such as Korean, that has many graphemes and many syllables decided by their combinations, upon selecting a Korean input mode, an initial keypad screen (key arrangement screen) having divided consonant and vowel regions may be displayed and a character input may be decided at each region and the switch from one region to another is configured to fix the selection of the target character in the previous region, thereby allowing a consecutive character input.

FIG. 3 illustrates an example of inputting a letter [symbol] using consonant and vowel parts (regions) in a Korean keypad structure in accordance with an exemplary embodiment.

In the first drawing of FIG. 3, for example, a part including numeric 1, 2, 4, 5, 7, 8 and 0 keys is assigned as a consonant key part (or consonant region) and a part including numeric 3, 6 and 9 keys is assigned as a vowel key part (or vowel region). Here, it is assumed that the numeric 1 key includes [symbol] the numeric 3 key includes [symbol] the numeric 6 key includes [symbol] and the numeric 9 key includes [symbol] .

If a user drags (for example, a finger on) the numeric 1 key (reference key) to the numeric 3 key (vowel region) in a state of touching the numeric 1 key (i.e., touch & drag), ‘ [symbol] ’ may be decided (selected) and the keypad may change to a state of waiting for input of a vowel. As the position is switched to the vowel region, as shown in the second drawing of FIG. 3, vowels and diphthongs associated with [symbol] are activated (displayed) on the consonant region, and if the user drags the touch to one of the activated vowels (i.e., select an associated key) and finally releases the touch input, a letter (word), composed by combination of the first decided consonant [symbol] and the vowel decided by the touch release, may be output (displayed).

When it is determined that the vowel input has been decided (selected), the consonant keypad may be re-activated (i.e., initialized) so as to implement a consecutive input of a final consonant. For example, the numeric 1 key is touched (input) to be dragged to a vowel region (e.g., numeric 3 key) without passing through a second or third column so as to decide (select) the input of [symbol] and the touch input is dragged back to the position of the numeric 1 key in a keypad, which is activated due to entry to the vowel region, to decide (select) a diphthong [symbol] thereby completing the input of vowel. Accordingly, the rest region is activated with consonant keys, to allow consecutive input of a final consonant. The dragging to the re-activated consonant key results in activating associated keys assigned to each key. Then, the touch input is dragged onto one of the associated keys and released therefrom, thereby completing input of the corresponding final consonant. As such, a letter desired to be input can be composed by one touch & drag and release.

Also, for input of a letter [symbol] if the numeric 4 key (reference key) having [symbol] is touched and such touch is dragged to the position of the numeric 6 key (associated key) having a vowel [symbol] the dragging from the consonant region to the vowel region is interpreted as a consonant character ( [symbol] ) being completely selected ( [symbol] is then set as a reference key again), and a character [symbol] and extension characters ( [symbol] [symbol] ) (associated keys) assigned to the position of the numeric [symbol] key are displayed (guided) on the consonant region. Since a target character is upon the touch input [symbol] being released at the position of the numeric 6 key, it is interpreted as the input of being completed. When the touch of the key is released, the keypad is initialized again to be back to the original key arrangement state (i.e., the first drawing).

Afterwards, upon a touch being applied on the numeric 0 key, the keypad as shown in the third drawing of FIG. 3 is activated. Since a target character is ‘ [symbol] ,’ upon the numeric 0 key being released, the final consonant ‘ [symbol] ’ is input. Those characters [symbol] [symbol] and ‘ [symbol] ’ are input in Korean automata, thereby sequentially outputting [symbol] and [symbol] .

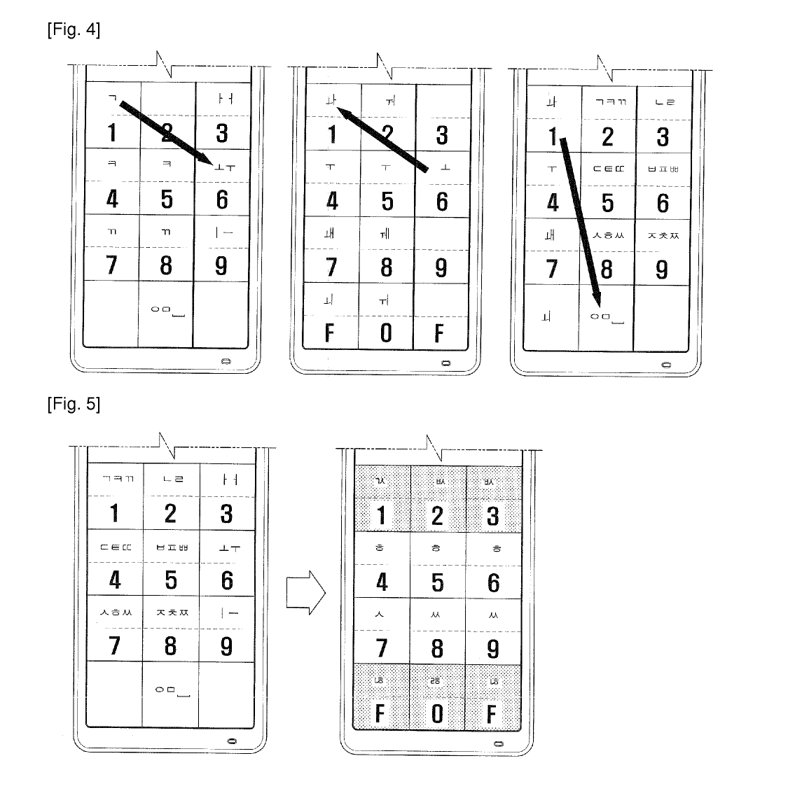

FIG. 4 illustrates another example of inputting a letter [symbol] using the consonant region and the vowel region in the Korean keypad structure in accordance with the exemplary embodiment.

First, when a user touches (inputs, enters) the numeric 1 key having [symbol] a keypad as shown in the first drawing is activated. Since it is at a consonant input step, the keypad having the numeric 3, 6 and 9 keys included in the vowel region is maintained the same as the initial screen.

Since a target vowel character is [symbol] the user drags the touch input from the numeric 1 key to the numeric 6 key having the vowel

[symbol]

As described above, since a finger is taken away from the consonant region, it is interpreted as the target character [symbol] has been selected. When the finger is present on the position of the numeric 6 key, the key arrangement as shown in the second drawing is activated. Since the target character is [symbol] the user drags his finger to the position of the numeric 1 key and releases the touch.

The present disclosure may not fix the consonant region and the vowel region.

That is, once a target character is selected, a keypad for input of the next character may be activated based on the corresponding position of the target character.

For example, if it is assumed that an input letter is [symbol] after the vowel [symbol] is selected in the second drawing, consonants key arrangement may be activated on the numeric 2, 3, 5, 6, 8, 9 and 0 keys as shown in the third drawing. Since a target character is ‘o’, the touch is dragged to the numeric 0 key and released, thereby completing the input of

[symbol]

Also, in regard of inputting a final consonant, for inputting [symbol] the existing method may need to perform a process of touching (pressing) a key (for example, the numeric 2 key) having [symbol] two times for input of [symbol] or touching (pressing) a specific key to convert [symbol] to [symbol] Also, the existing method may need to perform a process of touching (pressing) a key (e.g., numeric 7 key) having [symbol] two times for input of [symbol] or touching (pressing) a specific key in a state of ‘ [symbol] ’ being touched.

The present disclosure may be configured to assign geminates to keys, which are not defined as associated keys in relation to a specific reference key, thus to allow fast and simple input of the geminates through the simultaneous input mechanism. For example, as illustrated in FIG. 5, if [symbol] are assigned to the numeric 7 key, the numeric 7 key is touched (pressed) such that [symbol] and [symbol] can be assigned in plurality to the second row and the third row, respectively, to thusly be activated. Here, since keys present at the first row and the fourth row are not used, geminates including characters assigned to the numeric 7 key can be assigned, as follows, to those keys, thereby allowing fast input. That is, a geminate [symbol] including [symbol] may be assigned to the numeric 1 key, and another geminate [symbol] including [symbol] may be assigned to the numeric 2 key and the numeric 3 key so as to be used for input. Also, [symbol] may be assigned to the numeric 7 key of the fourth column, [symbol] may be assigned to the numeric 8 key, and [symbol] may be assigned again to the numeric 9 key, so as to be used for input.

As mentioned above, for assigning keys by dividing the consonant region and the vowel region, it may be possible to maintain the state of vowels being assigned to the numeric 3, 6 and 9 keys.

In the meantime, upon applying the embodiment of this specification, it may not be limited to a character input by employing a keyboard or keypad having 12 keys.

For English, 26 alphabets are used, so at least 2.6 graphemes may be assigned to each of 10 keys. That is, those keys may be divided into keys with 3 alphabets and keys with 2 alphabets. Thus, in order to know which alphabet is assigned to which key, it is necessary to remember not only 10 reference keys but also each position of the 10 reference keys, thereby causing a user's burden.

However, the present disclosure may implement a method for inputting a character using only 6 keys excluding function keys in case of being applied to a touch screen, which allows a burden of remembering a set of characters assigned to each key to be reduced and a dragging distance to be minimized. Also, each key may be large in size, which results in easy and accurate detection of a touch input position. A keypad (keyboard) having 9 keys will be configured as follows.

The method may be applied even to a conversion of a keypad without limit to an input of sentences. For example, in a mobile terminal having 12 keys, if it is assumed that a key located at the lowest end of the leftmost side is set as a keypad select key, Korean is assigned (set) to the numeric 1 key of the other 11 keys, Chinese to the numeric 2 key, Japanese to the numeric 3 key, English to the numeric 4 key, Number to the numeric 5 key, Arabic language to the numeric 6 key, Hebrew to the numeric 7 key and the like, when one of those keys is pressed in a state of the keypad select key being pressed, a keypad composed of the corresponding characters may be activated to be ready for following inputs. For example, if the numeric 5 key is pressed in the state of the keypad select key being pressed, the numeric keypad may be activated. For a touch screen, the switching of the keypad can be achieved in a manner that in a state of the keypad select key being touched, such touch is dragged to a key having characters of the corresponding language. For example, in the state of the keypad select key being touched, if the touch is dragged to the numeric 5 key and released, the numeric keypad can be set.

A method for inputting extension characters may vary depending on a language to be input and an input apparatus.

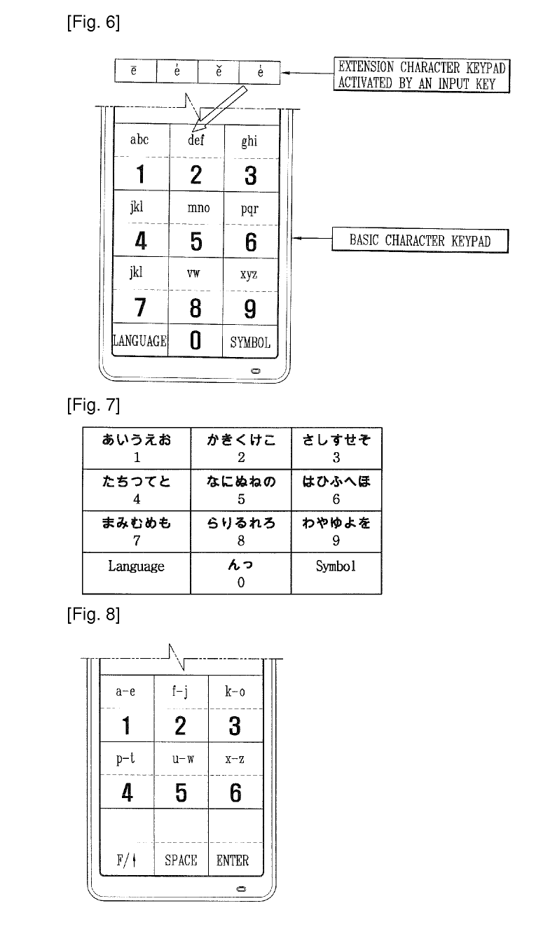

FIG. 6 illustrates an example of a multilingual key input method according to this specification.

For example, in regard of a typical cellular phone using key buttons, if it is assumed that three characters (alphabets) ‘d, e, f’ have been assigned to the numeric 2 key and any character has not been assigned to the numeric 0 key, in a state of the numeric 2 key being pressed, a key present at the second row from the top is entered to select ‘e’. Under this state, upon pressing the numeric 0 key, [symbol] corresponding to the first tone of ‘e’ may be activated on the numeric 1, 2 and 3 keys at the first row, [symbol] corresponding to the second tone of ‘e’ may be activated on the numeric 4, 5 and 6 keys, [symbol] [symbol] corresponding to the third tone may be activated on the numeric 7, 8 and 9 keys, and [symbol] corresponding to the fourth tone may be activated on keys present at right and left sides of the numeric 0 key.

In regard of a touch screen, this input method may be more simply implemented. For example, under assumption of a Chinese keypad being selected, if a key including vowels is touched, as illustrated in FIG. 6, a key arrangement including extension characters with tone marks of the corresponding vowels may be activated independent of a basic keypad, and displayed on a screen. Then, when such touch is dragged to the position of the corresponding key, the tone of the desired vowel may be input.

This method may be applied to a character input for a European language using alphabets. Unlike Chinese, for input of the European language, almost all of the alphabets may be special characters including diacritic marks. Hence, in the keypad for the European language, a separate key arrangement for guiding extension characters at every input step may be activated to be displayed on a screen, and a touch may be dragged to a corresponding position to allow easy and fast input of a target character.

For example, under assumption of a European keypad as illustrated in FIG. 6, upon touching the numeric 1 key, extension characters associated with ‘a’ may be displayed on an extension character window. In the state of the numeric 1 key being touched, when the touch is dragged to the third row from the top to select ‘c’, extension characters (e.g., [symbol] ) associated with ‘c’ may be displayed on the extension character window. Hence, the touch may then be dragged to a corresponding position, thereby allowing easy and fast input of a target character.

This method may also be applied to an input of Japanese.

FIG. 7 illustrates an example of a method for inputting Japanese according to the multilingual key input method.

As illustrated in FIG. 7, in regard of a Japanese keypad of a mobile terminal using a button-type keypad, if it is assumed that 5 Gana characters are assigned to each of numeric 1 to 9 keys and [symbol] and [symbol] are assigned to the numeric 0 key, when the numeric 1 key is pressed and then released, the first of plurality of characters assigned to the numeric 1 key is input. In the state of the numeric 1 key being pressed, a keypad, on which second to fifth characters assigned to the numeric 1 key are assigned from the top by a row unit, and a corresponding character may be input in response to an input of a second key. For example, in the state of the numeric 1 key being pressed, even if any key present at the second row from the top is pressed, the third character [symbol] can be input.

Also, Japanese language includes characters with sonant or semi-sonant marks. For input of such characters, a combination with the numeric 0 key may be utilized. For example, if the numeric 0 key is pressed in the state of the numeric 2 key being pressed, it may be configured to input [symbol] as a sonant of [symbol] For inputting a sonant of [symbol] which is the second character present on the numeric 2 key, in the state of the numeric 2 key being pressed, the numeric 1 or 3 key may be pressed to select [symbol] In the state the numeric 2 key or 1 or 3 key is still pressed, the numeric 0 key may be pressed to select

[symbol]

In regard of a device using a touch screen, if a key related to the sonant or semi-sonant is touched, a key arrangement, separate from a basic keypad, may be activated, and then sonant or semi-sonant of a corresponding character may be displayed on the activated key arrangement. The touch may then be dragged to the corresponding position of a target sonant or semi-sonant character, thereby allowing input of the target (desired) sonant or semi-sonant character without touch of the numeric 0 key.

This method may also be applied to a computer keyboard. In general, the computer keyboard includes a Shift key, a Space bar, an Enter key, a language convert key having a function of converting a keypad and the like as well as keys having characters. Especially, the language convert key may include two predetermined languages, which are the most frequently used, so it may allow to alternately select one of the two predetermined languages every time the language convert key is entered.

In this specification, upon the language convert key being entered, keys having characters may be converted into language (indicating) keys to be displayed, and a desired language key may be pressed to convert the keypad into a keypad of the desired language.

Preferably, a QWERTY-type keypad may be divided into a left side based on characters t, g, b and a right side based on characters y, h, n, and if a keypad select key is located close to one side, frequently used keys may be arranged at an opposite side.

In the state of being converted into the desired keypad according to the above method, the converted keypad may continuously be output on a screen to guide a position of a desired character. For example, if it is assumed that a keypad select key is located at the right of a Space bar, f-key may be pressed in a state of the keypad select key being pressed to activate a Russian keypad. In this state, the space bar may be pressed without release of the keypad select key to keep outputting the Russia key arrangement on a screen, thereby allowing input of a desired character with viewing the keypad.

A method for inputting a European language may be configured such that after selecting a European keypad according to the above method, if a space bar is pressed in a state of a desired alphabet being pressed, extension characters associated with the corresponding alphabet can be displayed (activated) at an opposite side to the corresponding alphabet and related contents (i.e., extension characters) can be displayed on a screen. Different extension characters may be set to each of keys. For example, extension characters of ‘a’ may be represented with various diacritic marks based on ‘a’ As such, extension characters may be set differently for every character.

A method for inputting Chinese Pinyin may be configured such that after activating a Chinese Pinyin keypad according to the above method, in a state of a vowel key being pressed, a specific key of the keypad present at an opposite side to the vowel key may be pressed to input a tone of the corresponding vowel. For example, in a state of ‘a’ being pressed, [symbol] corresponding to a first tone of ‘a’ can be input when j-key is pressed, [symbol] corresponding to the second tone of ‘a’ can be input when k-key is pressed, [symbol] corresponding to the third tone of ‘a can be input when the numeric 1 key is pressed, and [symbol] corresponding to the fourth tone of ‘a’ can be input when ‘;’ key is pressed.

Preferably, the second key, which selects a tone, may not be limited (fixed) but be input by pressing an opposite key to the position of a vowel desired to be input. For example, for inputting a vowel ‘i’, in the state of ‘i’ being input, the first tone of ‘i’ can be input when f-key is pressed, the second tone of ‘i’ can be input when d-key is pressed, the third tone of ‘i’ can be input when s-key is pressed, and the fourth tone of ‘i’ can be input when a-key is pressed. Also, this method may be configured to exhibit the same effect for each column or row unit without limit to a specific key. For example, such input can be implemented by a row unit such that in a state of ‘a’ being input, even when u-key right above j-key or m-key right below j-key is pressed, the first tone of ‘a’ can be input. The same method may also be applied to the second, third and fourth tones.

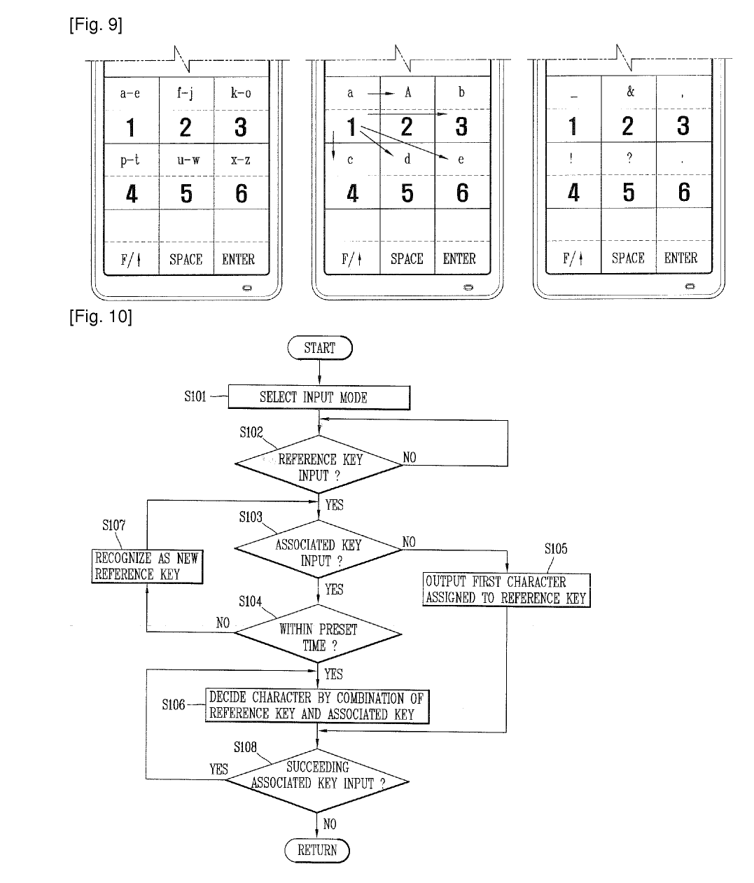

FIG. 8 illustrates a new English keypad structure in accordance with an exemplary embodiment, and FIG. 9 illustrates an example of inputting a character using the new English keypad.

As illustrated in FIG. 8, a keypad, in which 5 alphabets are assigned to each of numeric 1 to 4 keys and 3 alphabets are assigned to the numeric 5 and 6 keys, respectively, may be configured. This embodiment may be useful when more than a particular number of alphabets are assigned to each numeric key. Hence, in a state that a target character is one of five characters a, b, c, d, e, if the numeric 1 key is pressed (touched), associated keys are displayed (guided) adjacent to the numeric 1 key as illustrated in FIG. 9.

In a state of the numeric 1 key being touched, if the touch is dragged to the position of the numeric 2 key and then released, ‘A’ can be input, and if the touch is dragged to the position of the numeric 3 key and released, ‘b’ can be input. Similarly, in the same state, if the touch is dragged to the positions of the numeric 4, 5 and 6 keys, respectively, ‘c, d, e’ can be input, respectively. Here, the left key of the lowest column may be used as a shift key and a keypad select key. That is, when it is used individually, it may be used as the keypad select key as shown in the third drawing of FIG. 9. On the other hand, if it is used after another key is input, it may function as the shift key. The central key of the lowest column may be used as a space key, and a right key of the lowest column may be used as an enter key.

Also, when the enter key is simply input and then released, it may perform an enter key function. In the state of the enter key being input, it may activate (display) a new keypad (e.g., a punctuation marks keypad). Referring to the third drawing of FIG. 7, in the state of the enter key being touched, if such touch is dragged to the positions of the numeric 1 to 6 keys and then released, respectively, activated characters, namely, ‘.’, ‘,’, ‘?’, ‘!’, ‘-’, ‘&’ and the like may be input. The same method may also be applied to the space key.

Also, in the present disclosure, an oriented state of a cellular phone, such as an erect (vertical) state for input, a horizontal (laid) state for input may be detected (e.g., using a terrestrial magnetic sensor or gyro sensor). Accordingly, when the cellular phone changes from the vertical input state using a keypad with 12 keys or 9 keys to the horizontal state, the keypad of the cellular phone can be automatically converted into a QWERTY-type keypad with 33 to 45 keys.

The present disclosure may be configured to select a keypad, which is added according to requirements, such as a Korean mode, an English mode, a Japanese mode, a Chinese mode, a numerical mode and the like by inputting a preset key on an initial screen prior to input of a character.

However, the present disclosure may not be limited to the embodiment.

FIG. 10 is a flowchart illustrating an example of the multilingual key input method of FIG. 7 in accordance with an embodiment.

When a user selects a specific input mode (e.g., Korean, English, Japanese and

Chinese) (S101), a controller 140 may display an initial key arrangement (keypad) capable of inputting a language corresponding to the selected input mode on a screen of an output unit 120.

Upon the initial key arrangement (keypad) being displayed, the controller 140 may detect whether or not a plurality of keys are input. More particularly, the controller 140 may detect an input of a reference key (e.g., numeric 4 key) (i.e., an input of a first key or a reference key) (S102). When the reference key is input, the controller 140 may display the other characters, except for the first character, of a plurality of characters assigned to the reference key or extension characters on associated keys present at a specific column or row of a keyboard or keypad. Here, the controller 140 may distribute the characters included in the reference key on regions of the keyboard or keypad for displaying. Also, the controller 140 may display the extension characters on associated keys, which are displayed on regions excluding the region where the characters included in the reference key are displayed.

The associated keys may be keys for displaying characters included in the reference key on a specific column or row of the keyboard or touch screen. Thus, the controller 140 may determine them as the same key even if any one is input. Especially, the controller 140 may change a key arrangement and inputtable characters every time a basic (i.e., reference) key and an associated key are input and display the changed key arrangement and inputterable characters. Here, the key arrangement may be differently displayed according to the input order of the reference key and the associated key.

Also, the associated keys may be keys for displaying extension characters, not included in the reference key, on a specific column or row of a keyboard, keypad or touch screen. The extension characters may include alphabet characters including various diacritic marks, such as umlaut symbols, accent marks in French or the like, Japanese Gana characters having sonant or semi-sonant marks, characters for spelling Chinese Pinyin including tones from first to fourth tones, Korean diphthongs and geminates and the like.

The controller 140 may then detect whether or not an associated key is input within a preset time in a state of the reference key being input (S103 and S104).

If it is detected that the associated key is not input after input of the reference key (e.g., numeric 4 key), the first assigned character (e.g., g) of a plurality of characters (e.g., g, h, i) assigned to the reference key may be output to the output unit 120 (S105).

If it is detected that the associated key (the second key) is not input within a preset time (e.g., 0.5 second) after input of the reference key (e.g., numeric 4 key), the associated key may be determined as a new reference key (S107).

The controller 140 may not output any character assigned to a reference key while waiting for an input of an associated key for a preset time after input of the reference key. Alternatively, if an associated key is input after outputting a character assigned to a reference key, the controller 140 may convert the character into a character corresponding to combination of the reference key and the associated key.

When an associated key is input within a preset time after input of the reference key, the controller 140 may output a character corresponding to the combination of the reference key and the associated key (e.g., the first key and the second key) (S106). Here, if a succeeding key is input within a preset time, a character may not be output.

Afterwards, the controller 140 may wait for an input of a succeeding associated key for a preset time after selecting (deciding) one character by the reference key and the associated key (S108). If the succeeding associated key is not input within the preset time, then the controller 140 may maintain the character selected by the reference key and the associated key or output the selected character. If the succeeding associated key is input within the preset time, the controller 140 may use the character selected by the reference key and the associated key as a new reference key, thereby outputting a character selected by the new reference key and the succeeding associated key as a target character (S106). The processes may recursively be performed. Also, the character and the character selected by the succeeding associated key may include a character converted into a capital letter, and a character not assigned to the first key (e.g., a special character or a character with a nasal vowel symbol or a diacritic mark).

Detailed description thereof will be described hereinafter.

If it is detected that another key (e.g., the second key) is input within the preset time after input of the first key, the position of the second key is detected. A character corresponding to combination of the first key and the second key may be output according to the positions of the first and second keys. For the key combination, the internal memory 130 of the key input apparatus may store a character assignment table having various key combinations.

For example, it may be detected how many columns (or rows) the second key is away from the column (or row) having the first key (i.e., at which column (or row) the second key is present from the column (or row) having the first key). It may also be detected whether the second key is present at an upper column or lower column from the column having the first key. Alternatively, it may be detected whether the second key is present at a right row or a left row from the row having the first key. That is, it may be detected at which column or row the second key is located according to an option set for key combinations.

The position of the second key should be detected because the combination with the first key changes according to the position.

The position of the second key may be detected (determined) in the order of detecting from an upmost row to a lower row by excluding or including the first key, and detecting from the leftmost column to the right column by excluding or including the first key. The detection order may be preset by a user through a menu or a detection mode may be set by inputting a specific key.

Also, the present disclosure may be configured to automatically detect a key position according to an input method. For example, if a plurality of touches are input, the first touch may be interpreted as a first input value. If the second touch is simultaneously input, the second touch may be interpreted as a second input value. Or, if a dragging is generated after the first touch, a point at which a touch is released or a touch direction is changed can be interpreted as a second input value, a third input value or a fourth input value.

For example, if the second key, which is input following the first key (e.g., numeric 4 key), is present at the second row, the second assigned character (e.g., h) of a plurality of characters (e.g., g, h, i) assigned to the first key may be output, and if the second key is present at the third row, the third assigned character (e.g., i) of the plurality of characters (e.g., g, h, i) assigned to the first key may be output. As another example, if the second key, which is input following the first key (e.g., numeric 6 key), is present at the second row, the second assigned character (e.g., n) of a plurality of characters (e.g., m, n, o) assigned to the first key may be output, and if the second key is present at the third row, the third assigned key (e.g., o) of the plurality of characters (e.g., m, n, o) assigned to the first key may be output.

Meanwhile, if an option for the key combination is a combination by detecting a row of the second key, similar to the method for detecting the row, a character, which corresponds to the combination, of the characters assigned to the first key may be output according to whether or not the second key is present at the left column, the same column or the right column.

However, the present disclosure may not be limited to the embodiment. The character assignment according to the key combination may change according to an option set by a user. That is, combination of the first key and the second key and a character corresponding to the combination may be configured to be edited by a user. In other words, a combination of three or more keys may be set and a character corresponding to the combination may be assigned.

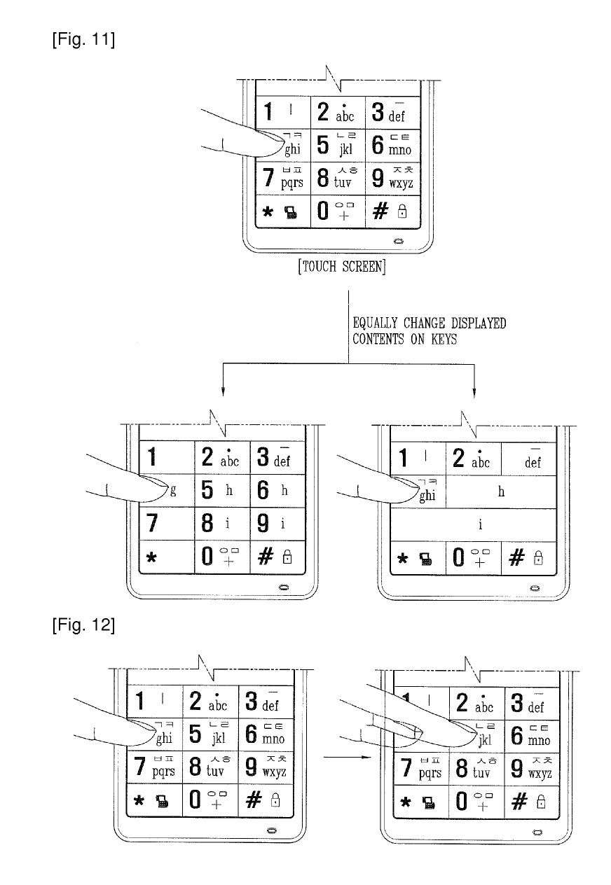

FIG. 11 is an exemplary view illustrating a recursive key input method in accordance with the present disclosure.

As aforesaid, the present disclosure may be configured to output a character corresponding to combination of a first key and a second key. Keys located at a specific column or row, input by the second key, may be detected as keys capable of inputting the same character. In other words, the second key may not be limited to a particular key but set as a certain key present at an upper or lower row of the row having the first key or the same row. Alternatively, the second key may be set as a certain key present at a left or right column of the column having the first key or the same column. Such setting may be executed by a user through a menu or be automatically converted every time a specific key excluding numeric keys is input.

For example, if the second key, input after the first key (e.g., numeric 4 key), belongs to the other keys (e.g., numeric 5 and 6 keys) present at the second row, even if any of the other keys at the second row is input, the second assigned character (e.g., h) of the plurality of characters (e.g., g, h, i) assigned to the first key may be equally output.

As another example, if the second key, input after the first key (e.g., numeric 4 key), belongs to the other keys (e.g., numeric 2, 5 and 8 keys) present at the second column, even if any of the other keys at the second column is input, the second assigned character (e.g., h) of the plurality of characters (e.g., g, h, i) assigned to the first key may be equally output.

The embodiment has illustrated that when keys present at a specific column or row are input, they are detected as keys capable of inputting the same character. However, in the present invention, the keys for detecting as the same input should not be always located at a specific column or row. For example, if many keys are arranged at a user input unit (e.g., keyboard), a specific region may be set such that even if any of keys present within the specific region is input, it can be detected as an input of the same key.

Therefore, referring to FIG. 11, if it is assumed that a user input unit (e.g., keypad or keyboard) is configured as a touch screen, contents (e.g., characters for each language) displayed by keys, which may be detected as an input of the same key, may be equally displayed to be guided to the user (i.e., a preview type).

For example, if a first key (e.g., numeric 4 key) is input, the controller 140 may equally display the displayed contents of keys present at the second row and the third row excluding the numeric 4 key. That is, the other keys (e.g., numeric 5 and 6 keys) at the second row may equally display the second assigned character (e.g., h) of a plurality of characters (e.g., g, h, i) assigned to the first key, and keys (e.g., numeric 7, 8 and 9 keys) present at the third row may equally display the third assigned character (e.g., i) of the plurality of characters (e.g., g, h, i) assigned to the first key.

The present disclosure, as aforesaid, may be implemented in a manner of maintaining a current state by generating a specific gesture (e.g., touch & hold and flicking) or pressing a specific key after input of the first key and then waiting for the succeeding input. That is, in a state that a user touches a first key (e.g., numeric 4 key), if the user drags the touch to a right side, then the controller 140 may maintain the state of the first key being input, and thereafter upon a second key being input, may output a character corresponding to the combination of the first key and the second key.

This method may also be effectively applied to a case in which one hand is in trouble or only one hand (or finger) can temporarily be used.

FIG. 12 illustrates another example of the recursive key input method according to the present disclosure.

The recursive key input method illustrated in FIG. 12 is a method of deciding (selecting) a character, which is output according to a distance of a touch & drag. Referring to FIG. 12, in a device employing a touch screen, in a state of one key being touched, if the touch is dragged to a position where a second key is present, a point at which the first touch is detected is regarded as a first key, and the dragged point is regarded as a second key.

For example, in a state of a first key (e.g., numeric 4 key) being touched, if the touch is dragged to a second key (numeric 5 key) present at a right of the first key, the second assigned character (e.g., h) of a plurality of characters (e.g., g, h, i) assigned to the first key may be output. Also, in the state of the first key (numeric 4 key) being touched, if the touch is dragged to a second key (numeric 6 key) present at the right of the first key, the third assigned character (e.g., i) of the plurality of characters (e.g., g, h, i) assigned to the first key may be output.

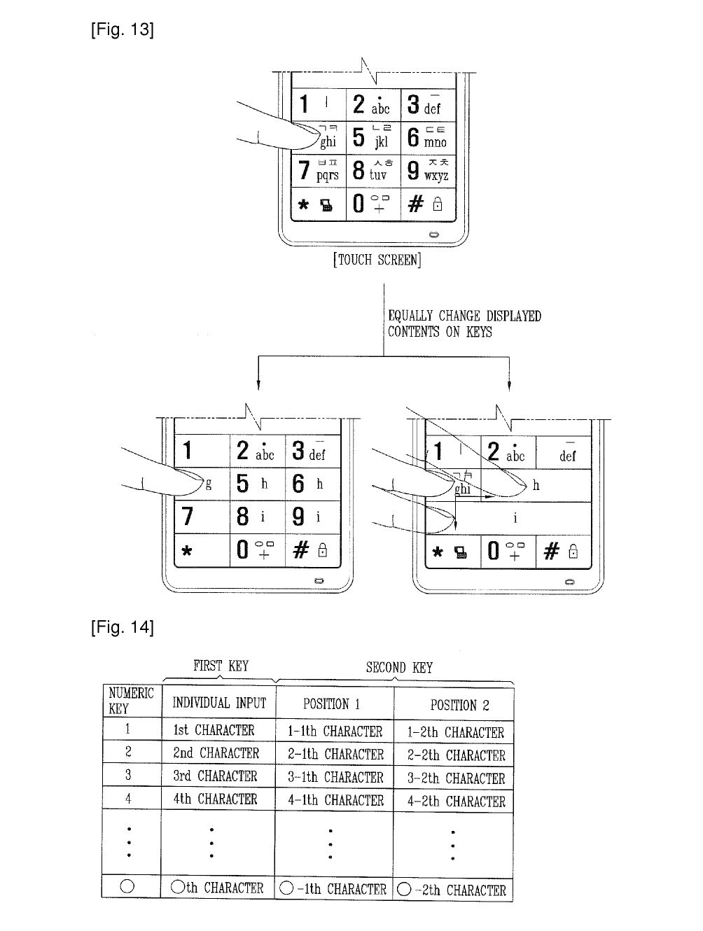

FIG. 13 illustrates another embodiment of the recursive key input method of FIG. 10, which may be applied to guiding a character assigned to a first key.

As illustrated in FIG. 13, when a user touches the first key (e.g., numeric 4 key), the controller 140 may display the same characters on keys present at the second and third columns on the same row excluding the numeric 4 key. In this state, if the user drags the touched first key to the second key (numeric 5 or 6 key) present at the right of the first key, the controller 140 may equally display the second assigned character (e.g., h) of the plurality of characters (e.g., g, h, i) assigned to the first key. On the other hand, in the state that the user touches the first key, if the user drags the touched first key to the lower third row, then the controller 140 may equally display the third assigned character (e.g., i) of the plurality of character (e.g., g, h, i) assigned to the first key.

Especially, the present disclosure may also be implemented in a manner of popping up only a key arrangement having keys as many as candidate characters to be input without conversion of the entire key arrangement when less characters are assigned to one key, depending on a language.

Also, the present disclosure may allow regions displayed upon conversion of a keyboard (keypad) arrangement to be different according to the number of characters assigned to one key.

That is, for example, regarding input of Japanese, if five characters [symbol] are assigned to the numeric 1 key, in a state of the numeric 1 key being pressed, a second key for assigning the other four characters thereto should be divided into four regions. In this case, it is necessary to assign [symbol] to the numeric 2 and 3 keys of the first row excluding the numeric 1 key, [symbol] to the numeric 4, 5 and 6 keys of the second row, [symbol] to the numeric 7, 8 and 9 keys of the third row, and [symbol] to a part or all of keys of the fourth row. Upon employing this method, a keyboard arrangement can be simplified.

As such, the contents (i.e., characters) displayed on each key arranged at the user input unit can be changed to inputtable characters, thereby enhancing user's convenience.

FIG. 14 illustrates an example of a memory table for a recursive key input in accordance with the present disclosure.

As mentioned above, in the present disclosure, the second key can be input in a state of the first key being input, and one of a plurality of characters assigned to the first key or another character related to the characters assigned to the first key can be output according to a combination of the first key and the second key. Here, the another character related to the characters assigned to the first key indicates a case that different characters represent first to fourth tones with respect to one vowel (e.g., a) as in Chinese. That is, assuming that a character assigned to the first key is ‘a’, another characters related to the character may be characters (e.g., ā, á, ä, à) representing first to fourth tones.

For the sake of explanation, it is assumed that at least three characters are assigned to each key (e.g., 0-9 keys). For example, it is assumed that a first character, a 1-1th character and a 1-2th character are assigned to the numeric 1 key, a second character, a 2-1th character and a 2-2th character are assigned to the numeric 2 key, and also three characters are assigned to each of other keys as illustrated in FIG. 5.

When each key is individually input, the first assigned character may be output. For example, if the numeric 4 key is individually input, the first assigned character (e.g., the fourth character) is output. In a state of the first key being input, if the second key is input, a character corresponding to the position of the second key, of characters assigned to the first key, may be output. For example, in the state of the numeric 4 key being input, the 4-1th character is output when a second key corresponding to a position 1 is input, and the 4-2th character is output when the second key corresponding to a position 2 is input.

Here, which numeric key is the second key may not be related to the character input and which characters are present on the second key may also not be related to the character input. However, a relative position of the second key with respect to the first key may be related to the character input. That is, a different character may be output according to whether the second key is present at the position 1 or the position 2. In other words, when the first and second keys are simultaneously input, a character assigned to the second key may not be output but a character corresponding to the combination with the second key, of characters assigned to the first key, may be output.

The embodiment has illustrated with reference to the keypad structure of the mobile terminal, but the same principle can be applied to a character input using a computer keyboard. Such principle can also be applied to inputting of characters not assigned to the first key (e.g., specific characters or characters with nasal vowel symbols or diacritic marks). The characters with the diacritic marks may include, for example, tones in Chinese, umlaut in German, accent aigu (´), accent grave (`) or accent circonflexe (̂) in French and the like.

For example, assuming input of Chinese, after activating a tone input by pressing a specific key, namely, * key or # key in a state of a certain vowel key (e.g., a) being input by a user, one of keys present at a preset region (e.g., each column or each row) may be selected so as to input a tone. Also, the present disclosure may be configured such that one of the specific keys (e.g., * key or # key) is set as a key for input of a capital letter, and the other key is set as a key for a character with a diacritic mark.

As described above, the preferred embodiments of this specification have been described with reference to the accompanying drawings.

Here, terms or words used in this specification and the claims should not be construed to be limited to meanings, which are typical or defined in the dictionary. Especially, if the first and second keys are input within a reference time, those keys may be used as the same as the reference key and the associated key. If the second key is input after the reference time, it may be used as a reference key. According to this method, the third key and the succeeding key may also be used as a new reference key or an associated key. In addition, the term ‘activated’ may be used as the same meaning as ‘displayed.’

As mentioned above, the present invention may provide an effect that keys having a plurality of characters can be fast input by using both hands or one hand.

Also, a succeeding associated key can be input by a recursive key input mechanism in a state of a specific character being selected, thereby facilitating an input of various extension characters related to a character, which is indicated by the corresponding key or combination of the corresponding key. Especially, specific characters, which are not basically assigned to keys, can also be conveniently input.

In addition, a character related to a key, which is input by a user, who is unfamiliar to key manipulation, and various extension characters related to the character can be provided in a preview form, thereby facilitating the character input. Also, the above configuration can provide an effect that specific characters not assigned to keys can be input by combination of a plurality of keys.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A multilingual key input method for inputting characters by a key input in a key arrangement including a plurality of keys, each having a plurality of characters assigned, the method comprising:
detecting whether or not a reference key is input;
activating a preset keypad or keyboard related to the reference key in response to the input of the reference key, to display at least one associated key having inputtable characters;
detecting whether or not the associated key is input within a preset time; and
outputting a character selected by the detected reference key and associated key or a character selected by using the selected character as a reference key and recursively using the succeeding key as an associated key as a target character.

2. The method of claim 1, wherein the reference key and the associated key are input by virtue of keys or touch, wherein the input of the reference key is a touch input and the input of the associated key is a touch & drag.

3-4. (canceled)

5. The method of claim 1, wherein the associated key is a key for displaying an extension character, not included in the reference key at a specific column or row of a keypad, a keyboard or a touch screen, wherein the extension characters comprise any characters other than the characters assigned to the reference keys including various diacritic marks including umlaut marks, accent marks in French, Japanese Gana characters having sonant or semi-sonant marks, Chinese Pinyin characters including tone marks from first to fourth tones, Korean diphthongs and geminates.

6. The method of claim 1, wherein the character selected by the reference key and the associated key comprises a plurality of characters assigned to the reference key or extension characters not assigned to the reference key.

7. The method of claim 1, wherein the target character composes a character assigned to the reference key, an extension character, a complete letter and a symbol including a punctuation mark, emoticon or the like.

8. The method of claim 1, wherein upon the reference key being input, the other characters excluding the first character of the plurality of characters assigned to the reference key or extension characters are displayed on associated keys present at a specific column or row of the keyboard or the keypad.

9. The method of claim 8, wherein the characters included in the reference key are displayed on divided regions of the keyboard or the keypad, and the extension characters are displayed on associated keys displayed on regions other than the regions for displaying the characters included in the reference key thereon.

10. The method of claim 1, wherein the key arrangement and the inputtable characters are displayed by being changed every time a reference key and an associated key are input, and the displayed key arrangement are differently displayed according to an input order of the reference key and the associated key.

11-15. (canceled)

16. The method of claim 1, wherein when the key arrangement is a Japanese keypad, a sonant or semi-sonant is input by a combination of each character key and numeric 0 key, or selected from a key arrangement to be input, the key arrangement being activated in response to an input of a specific key.

17. The method of claim 1, wherein when the key arrangement is an English keypad configured by assigning more than a preset number of alphabets to one numeric key, if a reference key is input in the corresponding key arrangement, associated keys related to the corresponding reference key are displayed adjacent to the reference key.

18-22. (canceled)

23. The method of claim 1, further comprising:
detecting input of one of keys having characters when a European language keypad is activated on a QWERTY-type keypad;
when one of keys without characters assigned is input in a state of a character key being input, activating extension characters related to the corresponding character on keys present opposite to the corresponding key; and
displaying the activated characters on a screen.

24. The method of claim 1, wherein the key arrangement is configured such that for a mobile terminal or computer using key buttons, when one of character keys having languages of each country is selected in a state of a language select key being pressed, the key arrangement is converted to a keypad of the corresponding language.

25. (canceled)

26. The key arrangement of claim 1, wherein the key arrangement is configured such that for a mobile terminal using a touch screen, when one of character keys having languages of each country is touched or is dragged to a specific numeric key in a state of a language select key being touched, the key arrangement is converted to a keypad of the corresponding language.

27-28. (canceled)

29. A multilingual key input apparatus for inputting a character by a key input in a key arrangement having a plurality of keys, each having a plurality of characters assigned, the apparatus comprising:
a user input unit configured to allow a user to input a key;
a memory configured to store a character assignment table corresponding to a plurality of key combinations;
a display unit configured to display a keypad arrangement converted responsive to the key input and a character decided based on the character assignment table in response to the key input; and
a controller configured to display at least one associated key including inputtable characters when a reference key is input, and to output a character selected by the detected reference key and associated key or a character selected by using the selected character as a reference key and recursively using the succeeding key as an associated key as a target character.

30. (canceled)

31. The apparatus of claim 29, wherein the associated key is a key for displaying a character included in the reference key at a specific column or row of a keyboard, a keypad or a touch screen, wherein even if any key on the same column or row is input, it is determined as the same key being input.

32. The apparatus of claim 29, wherein the associated key is a key for displaying an extension character, not included in the reference key at a specific column or row of a keypad, a keyboard or a touch screen, wherein the extension characters comprise alphabet characters including various diacritic marks including umlaut marks, accent marks in French, Japanese Gana characters having sonant or semi-sonant marks, Chinese Pinyin characters including tone marks from first to fourth tones, Korean diphthongs and geminates.

33. The apparatus of claim 29, wherein the character decided by the reference key and the associated key comprises a plurality of characters assigned to the reference key or extension characters not assigned to the reference key, the target character comprises a character assigned to the reference key, an extension character and a complete letter, and the associated key comprises a function key for inputting a special character including a punctuation mark or an emoticon.

34. The apparatus of claim 29, wherein the controller is configured to display the other characters excluding the first character of the plurality of characters assigned to the reference key or extension characters on associated keys present at a specific column or row of a keyboard, a keypad or a touch screen upon the reference key being input.

35. The apparatus of claim 29, wherein the controller is configured to display the characters included in the reference key on divided regions of a keyboard, a keypad or a touch screen and the extension characters are displayed on associated keys displayed on regions other than the regions for displaying the characters included in the reference key thereon.

36. The apparatus of claim 29, wherein the key arrangement and the inputtable characters are displayed by being changed every time a reference key and the associated key are input, the controller differently displaying the key arrangement according to an input order of the reference key and the associated key.

37. (canceled)
